(19) United States
(12) Patent Application Publication
(10) Pub. No.: US 2014/0373001 A1
(43) Pub. Date: Dec. 18, 2014

(54) ELECTRONIC DEVICE, SOFTWARE UPDATING SYSTEM AND METHOD

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: YIN-ZHAN WANG, Shenzhen (CN)

(21) Appl. No.: 14/306,499

(22) Filed: Jun. 17, 2014

(30) Foreign Application Priority Data
Jun. 18, 2013 (CN) 2013102428387

(51) Int. Cl. G06F 9/445; G06F 9/44

(52) U.S. Cl. CPC G06F 8/65; G06F 8/71
USPC 717/170

(57) ABSTRACT

A software updating system and method detects each item of existing software installed in an electronic device and obtains version information of each item. The availability of a newer version of the installed software is determined, newer version information obtained, comparing the version information of the existing software with the version information of the newer software, and determining any improvements offered by the newer version. Finally, issuing an updating suggestion recommending installation, making no recommendation, or recommending non-installation of the newer software depending on improvements or other features found.

### CROSS-REFERENCE TO RELATED APPLICATIONS

This application claims priority to Chinese Patent Application No. 201310242838.7 filed on Jun. 18, 2013 in China Intellectual Property Office, the contents of which are incorporated by reference herein.

### FIELD

The subject matter herein generally relates to software updating.

### BACKGROUND

Software installed in electronic devices needs to be updated regularly, and users are often reminded to update the installed software.

### BRIEF DESCRIPTION OF THE DRAWINGS

Implementations of the present technology will now be described, by way of example only, with reference to the attached figures.

FIG. 1 is a block diagram of an electronic device running a software updating system, in accordance with an exemplary embodiment.

FIG. 2 is a flowchart of a software updating method, in accordance with an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein, However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Definitions that apply throughout disclosure will now be presented.

The term “comprising” means “including, but not necessarily limited to”, it specifically indicates open-ended inclusion or membership in a so-described combination, group, series and the like.

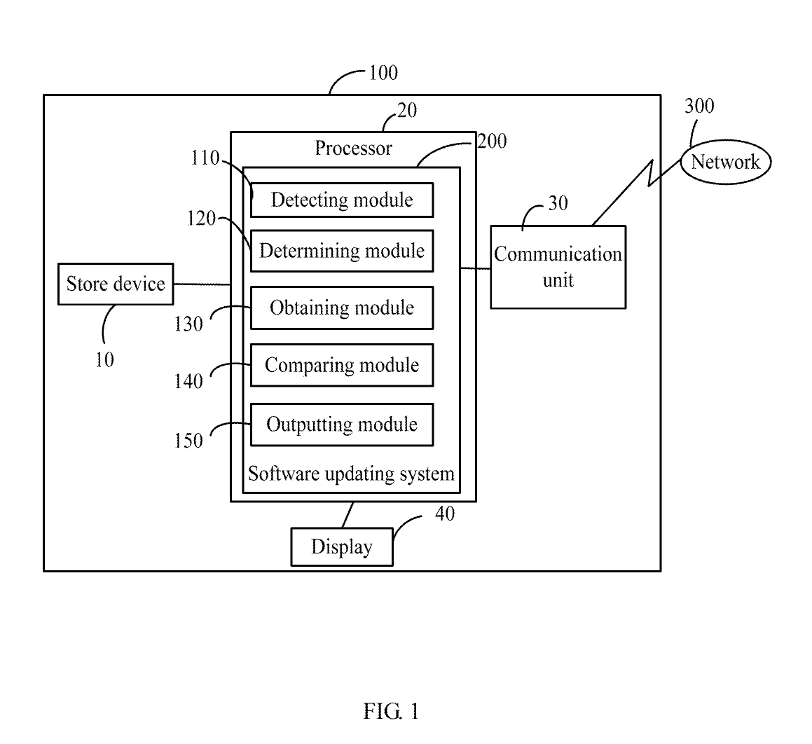

FIG. 1 illustrates an example embodiment of an electronic device running a software updating system. The electronic device 100 can install and run a variety of software. The electronic device 100 includes a storage device 10, a processor 20, a communication unit 30, and a display 40. The electronic device 100 can be a mobile phone or a computer. The storage device 10 can be a smart media card, a secure digital card, or a flash card. The processor 20 can be, but is not limited to being, a central processing unit, a single chip, or a digital signal processor. The display unit 40 can be a touch screen, a liquid crystal display panel, or the like.

The storage device 10 can store the variety of existing software. Each item of existing software includes a version information, the version information can include a version number, an issued date, and a function description of the software.

The electronic device 100 can run a software updating system 200 to update the existing software installed in the electronic device 100. The software updating system 200 can include a number of modules, which are a collection of software instructions executed by the processor 20.

The software updating system 200 can include a detecting module 110, a determining module 120, an obtaining module 130, a comparing module 140, and an outputting module 150.

The detecting module 110 detects each item of existing software installed in the electronic device 100 and obtains the version information of each item of software. In at least one embodiment, the detecting module 110 detects each item of software installed in the electronic device 100 and obtains the version information of each item of software once the electronic device 100 is turned on. In another embodiment, the detecting module 110 determines the software and obtains the version information of the software in response to a user input.

The determining module 120 connects to a network 300 via the communication unit 30 and detects whether a newer version of the existing software is available on the network 300. In at least one embodiment, the determining module 120 accesses a website or web store via the communication unit 30 to determine whether a newer version of the software is available on the website or web store by determining the version number and the issue date of the newer software of the website or web store. In at least one embodiment, the determining module 120 executes the above functions, such as determining the newer version of the software when the existing software has not been updated for a preset period of time.

If the determining module 120 determines that a newer version of the existing software is available on the website or the web store, the obtaining module 130 obtains the information as to the newer version from the website or the web store via the communication unit 30. In at least one embodiment, the newer version information of the software also can include a version number, an issue date, and a function description of the software.

The comparing module 140 compares the version information of the existing software with the newer version information, and determines the improvements offered by the newer version. In detail, the comparing module 140 determines the improvements by comparing the function description of the software in the version information of the existing software and the function description of the software in the newer version information. The improvements determined by the comparing module can include functional improvements, such as removing advertisements from the software, user interface improvements, such as a better visual interface of the newer software, and software refinement (that is, eradication of bugs and errors), the software maintenance might not change user experiences.

The outputting module 150 gives a suggestion to update according to any improvements of the newer version software determined by the comparing module 140, and displays the suggestion on the display 40 to help the user to determine whether or not to update the existing software. In at least one embodiment, the updating suggestion can be pre-configured by a user. In at least one embodiment, if the comparing module 140 determines that the improvements of the newer version of the software is a functional improvement, the outputting module 150 designates the updating suggestion as a recommended updating of the existing software; if the comparing module 140 determines that the improvements of the newer version of the software is a user interface improvement, the outputting module 150 designates the updating suggestion as an option depending on user preferences; and if the comparing module 140 determines that the improvements of the newer version of the software is a software refinement, the outputting module 150 determines the updating suggestion as recommending non-installation of the update.

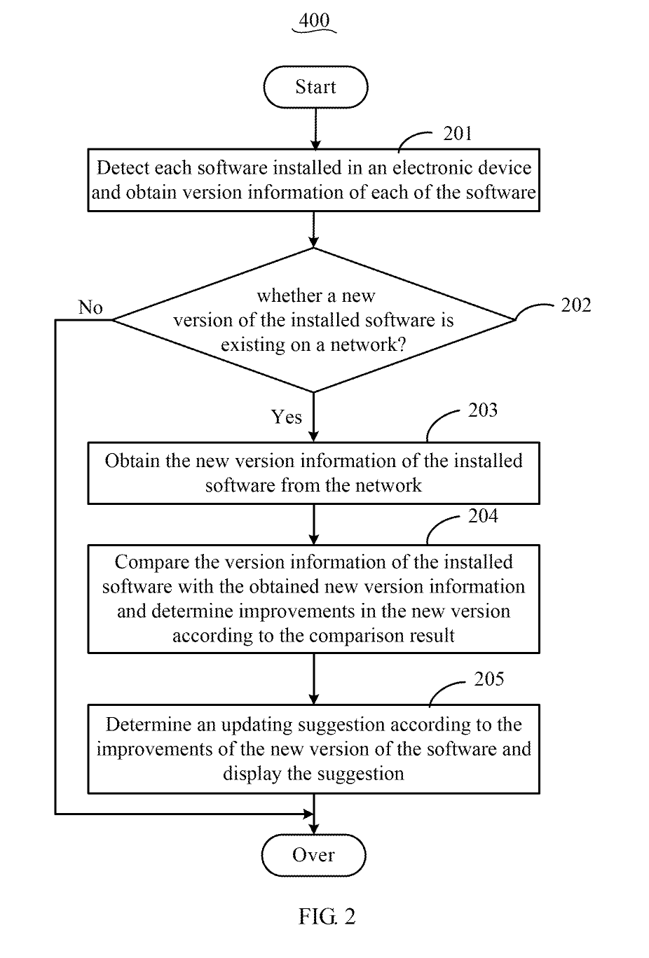

FIG. 2 illustrates a flowchart in accordance with an example embodiment. The example software updating method 400 is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Additionally, the illustrated order of blocks is by example only and the order of the blocks can be changed. The example software updating method can begin at block 201.

At block 201, a detecting module detects each item of software already installed in an electronic device and obtains version information of each item of software installed in the electronic device.

At block 202, a determining module connects to a network via a communication unit and detects whether a newer version of the installed and existing software is available on a website or a web store, if yes, the procedure proceeds to block 203; if no, the procedure is ends.

At block 203, an obtaining module obtains information as to the newer version of the software from the website or the web store.

At block 204, a comparing module compares the version information of the existing software with information as to the newer version of the installed software, and determines any improvements offered by the newer version of the installed software according to the comparison.

At block 205, an outputting module determines a updating suggestion according to any improvements or otherwise of the newer version software, as determined by the comparing module 140, and displays the suggestion on a display to help the user to determine whether to update the existing software.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic device configured to install a variety of software, the electronic device comprising:
a storage device configured to store the variety of software, each item of software comprising a version information;
a processor coupled to the storage device;
a detecting module, stored on the storage device, comprising instructions to cause the processor to detect each item of software installed on the electronic device and obtain version information of each item of software installed on the electronic device;
a determining module, stored on the storage device, comprising instructions to cause the processor to determine whether a newer version of at least one of the installed software is available;
an obtaining module, stored on the storage device, comprising instructions to cause the processor to obtain information regarding a the new version of the installed software if the determining module determines that the newer version of the at least one installed software is available;
a comparing module, stored on the storage device, comprising instructions to cause the processor to compare the version information of the least one installed software with the information as to the newer version of the at least one installed software and determine any improvements offered by the newer version of the at least one installed software according to a result of the comparison; and
an outputting module, stored on the storage device, comprising instructions to cause the processor to provide a suggestion to update according to the newer version of the at least one installed software determined by the comparing module.

2. The electronic device as described in claim 1, wherein the determining module cause the processor to determine whether the newer version of the at least one installed software is available when the at least one installed software has not been updated for a preset period of time.

3. The electronic device as described in claim 1, wherein the version information comprises a version number, an issued date, and a function description of the software, the comparing module cause the processor to determine the improvements by comparing the function description of the software in the version information of the installed software and the function description of the software in the information as to the newer version of the at least one installed software.

4. The electronic device as described in claim 1, wherein the improvements determined by the processor comprise functional improvements, user interface improvements, and software refinement; if the processor determines that the improvements of the newer version of the software is a functional improvement, the outputting module cause the processor to designate the updating suggestion as a recommended updating of the installed software; if the processor determines that the improvements of the newer version of the software is a user interface improvement, the outputting module cause the processor designate the updating suggestion as an option depending on user preferences; and if the processor determines that the improvements of the newer version of the software is a software refinement, the outputting module cause the processor to determine the updating suggestion as recommending non-installation of the update.

5. The electronic device as described in claim 4, further comprising a display coupled to the processor to display the suggestion given by the outputting module.

6. A software updating method applied in an electronic device, the electronic device installing a variety of software, each item of the installed software comprising a version information, the method comprising:
detecting each item of the software installed in the electronic device and obtaining version information of each item of the software installed in the electronic device;
determining whether a newer version of at least one of the installed software is available;
obtaining information as to the newer version of the at least one installed software if determining that the newer version of the at least one installed software is available;
comparing the version information of the at least one installed software with the information as to the newer version of the at least one installed software, and determining any improvements offered by the newer version of the at least one installed software according to a comparison result; and
determining a suggestion to update according to the improvements of the newer version of the at least one installed software.

7. The software updating method as described in claim 6, wherein detecting whether the newer version of the at least one installed software is available when the at least one installed software has not been updated for a preset period of time.

8. The software updating method as described in claim 6, wherein the version information comprises a version number, an issued date, and a function description of the software, the improvements offered by the newer version of the software is determined by comparing the function description of the software in the version information of the installed software and function description of the software in the information as to the newer version of the at least one installed software.

9. The software updating method as described in claim 6, wherein the determined improvements comprise functional improvements, user interface improvements, and software refinement; if the improvements of the newer version of the software is a functional improvement, the updating suggestion is designated as a recommended updating of the installed software; if the improvements of the newer version of the software is a user interface improvement, the updating suggestion is designated as an option depending on user preferences; and if the improvements of the new version of the software is refinement, the updating suggestion is designated as recommending non-installation of the update.

10. The software updating method as described in claim 9, further comprising:
displaying the suggestion on a display.
